(19) United States
(12) Patent Application Publication
(10) Pub. No.: US 2026/0183658 A1
(43) Pub. Date: Jul. 2, 2026

(54) PENALTY-BASED SCHEDULING METHOD FOR BETTER VIDEO GAME POWER

(71) Applicant: QUALCOMM Incorporated, San Diego, CA (US)

(72) Inventors: Yanwu WANG, Dongguan (CN); Ning SUN, Beijing (CN); Yongjun DAI, Shanghai (CN)

(21) Appl. No.: 19/125,500

(22) PCT Filed: Dec. 28, 2022
(86) PCT No.: PCT/CN2022/142690

§ 371 Date: Apr. 29, 2025

(51) Int. Cl. A63F 13/52; G06F 9/48

(52) U.S. Cl. CPC A63F 13/52; G06F 9/4881

(57) ABSTRACT

A method for penalty-based game thread task load scheduling is described. The method includes comparing a current frames per second (FPS) value of a game thread to a target FPS value. The method also includes detecting frame headroom of the game thread when the current FPS value of the game thread is not less than the target FPS value. The method further includes penalizing a task load of the game thread in response to detecting the frame headroom. The method also includes propagating a hint to a task scheduler including the penalized task load of the game thread.

### FIELD OF THE DISCLOSURE

The present disclosure relates generally to processing systems and, more particularly, to one or more techniques for penalty-based scheduling to achieve improved video game power performance.

### BACKGROUND

Computing devices often utilize a graphics processing unit (GPU) to accelerate the rendering of graphical data for display. Such computing devices may include, for example, computer workstations, mobile phones such as smartphones, embedded systems, personal computers, tablet computers, and video game consoles. GPUs execute a graphics processing pipeline that includes various processing stages that operate together to execute graphics processing commands and output a frame. A central processing unit (CPU) may control the operation of the GPU by issuing one or more graphics processing commands to the GPU. Modem day CPUs are capable of concurrently executing multiple applications, each of which may need to utilize the GPU during execution. A device that provides content for visual presentation on a display generally includes a graphics processing unit (GPU) and operates at a desired number of frames per second (FPS).

The mobile gaming market is becoming one of the most important markets in the mobile world. In this market, users care greatly about the game performance. Frames per second (FPS) is an important key performance indicator (KPI). Video game applications running on a mobile device may desire to improve battery life by controlling power consumption when a user plays a game on the mobile device. For example, a game application running on the mobile device may control content FPS to reduce power consumption and improve battery life of the mobile device. Unfortunately, conventional techniques for controlling the content FPS are not power optimal and lead to a high number of wasted CPU cycles. A technique for controlling content FPS to reduce power consumption and improve battery life of the mobile device is desired.

### SUMMARY

A method for penalty-based game thread task load scheduling is described. The method includes comparing a current frames per second (FPS) value of a game thread to a target FPS value. The method also includes detecting frame headroom of the game thread when the current FPS value of the game thread is not less than the target FPS value. The method further includes penalizing a task load of the game thread in response to detecting the frame headroom. The method also includes propagating a hint to a task scheduler including the penalized task load of the game thread.

A non-transitory computer-readable medium having program code recorded thereon for penalty-based game thread task load scheduling is described. The program code is executed by a processor. The non-transitory computer-readable medium includes program code to compare a current frames per second (FPS) value of a game thread to a target FPS value. The non-transitory computer-readable medium also includes program code to detect frame headroom of the game thread when the current FPS value of the game thread is not less than the target FPS value. The non-transitory computer-readable medium further includes program code to penalize a task load of the game thread in response to detecting the frame headroom. The non-transitory computer-readable medium also includes program code to propagate a hint to a task scheduler including the penalized task load of the game thread.

This has outlined, rather broadly, the features and technical advantages of the present disclosure in order that the detailed description that follows may be better understood. Additional features and advantages of the present disclosure will be described below. It should be appreciated by those skilled in the art that the present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF DRAWINGS

The details of one or more examples of the disclosure are set forth in the accompanying drawings and the description below. Other features, objects, and advantages of the disclosure will be apparent from the description and drawings, and from the claims.

FIG. 1 is a block diagram that illustrates an example content generation and coding system to implement penalty-based game thread load scheduling, in accordance with aspects of the present disclosure.

FIG. 2 is an example flow diagram between a source device and a destination device in which penalty-based game load scheduling is performed, in accordance with aspects of the present disclosure.

FIG. 3 is an example timing diagram showing game content frame rate control, according to aspects of the present disclosure.

FIGS. 4A and 4B are example timing diagrams showing control of content frames per second (FPS) based on different central processing unit (CPU) operating frequencies, according to aspects of the present disclosure.

FIG. 4C is a timing diagram based on the yield frames per second (FPS) control method, according to aspects of the present disclosure.

FIG. 5 is an example flow diagram showing thread scheduling during a scheduler yield operation, according to aspects of the present disclosure.

FIG. 6 is a flowchart illustrating a method for penalty-based, game thread load scheduling, according to aspects of the present disclosure.

FIG. 7 is a state diagram further illustrating a closed-loop method for the penalty-based game thread load scheduling of FIG. 6, according to aspects of the present disclosure.

FIGS. 8A-8B illustrate a timing diagram to implement scheduler yield subtraction and a flowchart illustrating a scheduler yield subtraction of the penalty-based game thread load scheduling, according to aspects of the present disclosure.

FIG. 9 is a flowchart illustrating a method for penalty-based game thread load scheduling, according to aspects of the present disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems on a chip (SoC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application (i.e., software) being configured to perform one or more functions. In such examples, the application may be stored on a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and executed the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In general, this disclosure describes techniques for having a distributed graphics processing pipeline across multiple devices, improving the coding of graphical content, and/or reducing the load of a processing unit (i.e., any processing unit configured to perform one or more techniques described herein, such as a graphics processing unit (GPU)). For example, this disclosure describes techniques for graphics processing in communication systems. Other example benefits are described throughout this disclosure.

As used herein, the term “coder” may generically refer to an encoder and/or decoder. For example, reference to a “content coder” may include reference to a content encoder and/or a content decoder. Similarly, as used herein, the term “coding” may generically refer to encoding and/or decoding. As used herein, the terms “encode” and “compress” may be used interchangeably. Similarly, the terms “decode” and “decompress” may be used interchangeably.

As used herein, instances of the term “content” may refer to the term “video,” “graphical content,” “image,” and vice versa. This is true regardless of whether the terms are being used as an adjective, noun, or other part of speech. For example, reference to a “content coder” may include reference to a “video coder,” “graphical content coder,” or “image coder,” and reference to a “video coder,” “graphical content coder,” or “image coder” may include reference to a “content coder.” As another example, reference to a processing unit providing content to a content coder may include reference to the processing unit providing graphical content to a video encoder. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

As used herein, instances of the term “content” may refer to graphical content or display content. In some examples, as used herein, the term “graphical content” may refer to a content generated by a processing unit configured to perform graphics processing. For example, the term “graphical content” may refer to content generated by one or more processes of a graphics processing pipeline. In some examples, as used herein, the term “graphical content” may refer to content generated by a graphics processing unit. In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling (e.g., upscaling or downscaling) on a frame. In some examples, a frame may refer to a layer. In other examples, a frame may refer to two or more layers that have already been blended together to form the frame (i.e., the frame includes two or more layers, and the frame that includes two or more layers may subsequently be blended)

As referenced herein, a first component (e.g., a processing unit) may provide content, such as graphical content, to a second component (e.g., a content coder). In some examples, the first component may provide content to the second component by storing the content in a memory accessible to the second component. In such examples, the second component may be configured to read the content stored in the memory by the first component. In other examples, the first component may provide content to the second component without any intermediary components (e.g., without memory or another component). In such examples, the first component may be described as providing content directly to the second component. For example, the first component may output the content to the second component, and the second component may be configured to store the content received from the first component in a memory, such as a buffer.

The mobile gaming market is an important market in the mobile world. In this market, users care greatly about the game performance. Frames per second (FPS) is an important key performance indicator (KPI). Game applications running on a mobile device may desire to improve battery life by controlling power consumption when a user plays a game on the mobile device. For example, a game application running on the mobile device may control content FPS to reduce power consumption and improve battery life of the mobile device. Conventional game FPS control may include forcing the game thread to sleep and/or performing a scheduler yield operation to enable execution of another thread during a frame headroom time. Unfortunately, conventional techniques for controlling the content FPS are not power optimal and lead to a high number of wasted CPU cycles. A technique for controlling content FPS to reduce power consumption and improve battery life of the mobile device is desired.

Some aspects of the present disclosure provide a number of advantages and solutions to the mobile gaming industry, such as providing improved game FPS control. These aspects of the present disclosure rely on penalty-based scheduling to provide game FPS control that reduces power consumption and improves battery life of the mobile device. In some aspects of the present disclosure, the penalty-based scheduling method compares a current frames per second (FPS) value of a game thread to a target FPS value. This comparison detects frame headroom of the game thread when the current FPS value of the game thread not less than the target FPS value, which triggers game FPS control. In accordance with some aspects of the present disclosure, the detection of frame headroom results in penalizing a task load of the game thread. This penalized task load is propagated as a hint to a task scheduler, which results in a reduced processor frequency until a frame drop is detected.

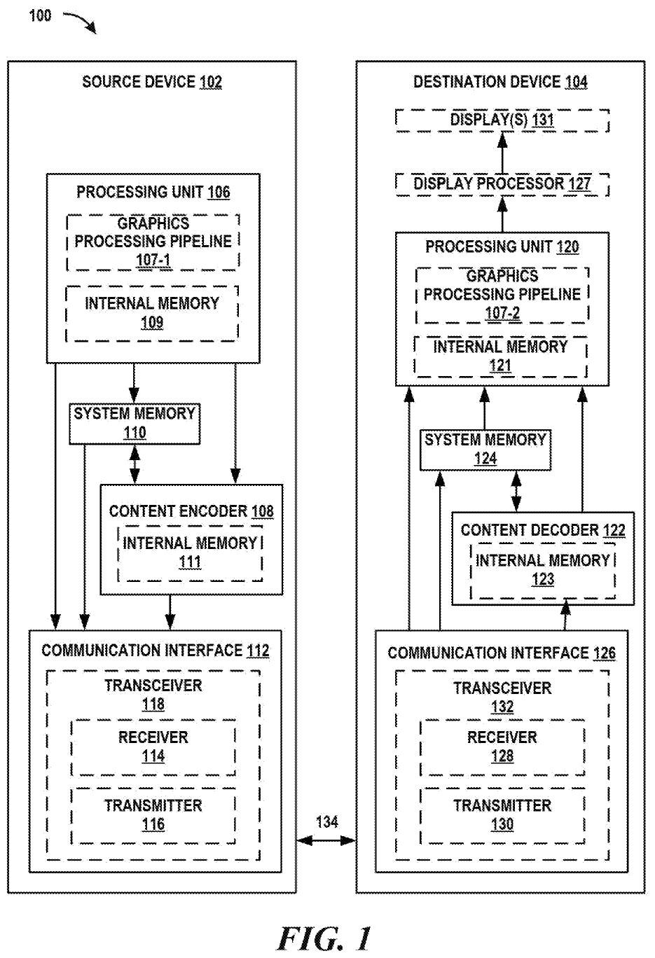

FIG. 1 is a block diagram that illustrates an example content generation and coding system 100 configured to implement penalty-based game thread load scheduling, according to aspects of the present disclosure. The content generation and coding system 100 includes a source device 102 and a destination device 104. In accordance with the techniques described herein, the source device 102 may be configured to encode, using the content encoder 108, graphical content generated by the processing unit 106 prior to transmission to the destination device 104. The content encoder 108 may be configured to output a bitstream having a bit rate. The processing unit 106 may be configured to control and/or influence the bit rate of the content encoder 108 based on how the processing unit 106 generates graphical content.

The source device 102 may include one or more components (or circuits) for performing various functions described herein. The destination device 104 may include one or more components (or circuits) for performing various functions described herein. In some examples, one or more components of the source device 102 may be components of a system-on-chip (SOC). Similarly, in some examples, one or more components of the destination device 104 may be components of an SOC.

The source device 102 may include one or more components configured to perform one or more techniques of this disclosure. In the example shown, the source device 102 may include a processing unit 106, a content encoder 108, a system memory 110, and a communication interface 112. The processing unit 106 may include an internal memory 109. The processing unit 106 may be configured to perform graphics processing, such as in a graphics processing pipeline 107-1. The content encoder 108 may include an internal memory 111.

Memory external to the processing unit 106 and the content encoder 108, such as system memory 110, may be accessible to the processing unit 106 and the content encoder 108. For example, the processing unit 106 and the content encoder 108 may be configured to read from and/or write to external memory, such as the system memory 110. The processing unit 106 and the content encoder 108 may be communicatively coupled to the system memory 110 over a bus. In some examples, the processing unit 106 and the content encoder 108 may be communicatively coupled to each other over the bus or a different connection.

The content encoder 108 may be configured to receive graphical content from any source, such as the system memory 110 and/or the processing unit 106. The system memory 110 may be configured to store graphical content generated by the processing unit 106. For example, the processing unit 106 may be configured to store graphical content in the system memory 110. The content encoder 108 may be configured to receive graphical content (e.g., from the system memory 110 and/or the processing unit 106) in the form of pixel data. Otherwise described, the content encoder 108 may be configured to receive pixel data of graphical content produced by the processing unit 106. For example, the content encoder 108 may be configured to receive a value for each component (e.g., each color component) of one or more pixels of graphical content. As an example, a pixel in the RGB color space may include a first value for the red component, a second value for the green component, and a third value for the blue component.

The internal memory 109, the system memory 110, and/or the internal memory 111 may include one or more volatile or non-volatile memories or storage devices. In some examples, internal memory 109, the system memory 110, and/or the internal memory 111 may include random access memory (RAM), static RAM (SRAM), dynamic RAM (DRAM), erasable programmable ROM (EPROM), electrically erasable programmable ROM (EEPROM), Flash memory, a magnetic data media or an optical storage media, or any other type of memory.

The internal memory 109, the system memory 110, and/or the internal memory 111 may be a non-transitory storage medium according to some examples. The term “non-transitory” may indicate that the storage medium is not embodied in a carrier wave or a propagated signal. However, the term “non-transitory” should not be interpreted to mean that internal memory 109, the system memory 110, and/or the internal memory 111 is non-movable or that its contents are static. As one example, the system memory 110 may be removed from the source device 102 and moved to another device. As another example, the system memory 110 may not be removable from the source device 102.

The processing unit 106 may be a central processing unit (CPU), a graphics processing unit (GPU), a general purpose GPU (GPGPU), or any other processing unit that may be configured to perform graphics processing. In some examples, the processing unit 106 may be integrated into a motherboard of the source device 102. In some examples, the processing unit 106 may be present on a graphics card that is installed in a port in a motherboard of the source device 102, or may be otherwise incorporated within a peripheral device configured to interoperate with the source device 102.

The processing unit 106 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 106 may store instructions for the software in a suitable, non-transitory computer-readable storage medium (e.g., internal memory 109), and may execute the instructions in hardware using one or more processors to perform the techniques of this disclosure. Any of the foregoing (including hardware, software, a combination of hardware and software, etc.) may be considered to be one or more processors.

The content encoder 108 may be any processing unit configured to perform content encoding. In some examples, the content encoder 108 may be integrated into a motherboard of the source device 102. The content encoder 108 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the content encoder 108 may store instructions for the software in a suitable, non-transitory computer-readable storage medium (e.g., internal memory 111), and may execute the instructions in hardware using one or more processors to perform the techniques of this disclosure. Any of the foregoing (including hardware, software, a combination of hardware and software, etc.) may be considered to be one or more processors.

The communication interface 112 may include a receiver 114 and a transmitter 116. The receiver 114 may be configured to perform any receiving function described herein with respect to the source device 102. For example, the receiver 114 may be configured to receive information from the destination device 104, which may include a request for content. In some examples, in response to receiving the request for content, the source device 102 may be configured to perform one or more techniques described herein, such as produce or otherwise generate graphical content for delivery to the destination device 104. The transmitter 116 may be configured to perform any transmitting function described herein with respect to the source device 102. For example, the transmitter 116 may be configured to transmit encoded content to the destination device 104, such as encoded graphical content produced by the processing unit 106 and the content encoder 108 (i.e., the graphical content is produced by the processing unit 106, which the content encoder 108 receives as input to produce or otherwise generate the encoded graphical content). The receiver 114 and the transmitter 116 may be combined into a transceiver 118. In such examples, the transceiver 118 may be configured to perform any receiving function and/or transmitting function described herein with respect to the source device 102.

The destination device 104 may include one or more components configured to perform one or more techniques of this disclosure. In the example shown, the destination device 104 may include a processing unit 120, a content decoder 122, a system memory 124, a communication interface 126, and one or more displays 131. Reference to the displays 131 may refer to the one or more displays 131. For example, the displays 131 may include a single display or a plurality of displays. The displays 131 may include a first display and a second display. The first display may be a left-eye display and the second display may be a right-eye display. In some examples, the first and second display may receive different frames for presentment thereon. In other examples, the first and second display may receive the same frames for presentment thereon.

The processing unit 120 may include an internal memory 121. The processing unit 120 may be configured to perform graphics processing, such as in a graphics processing pipeline 107-2. The content decoder 122 may include an internal memory 123. In some examples, the destination device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display content that was generated using decoded content. For example, the display processor 127 may be configured to process one or more frames generated by the processing unit 120, where the one or more frames are generated by the processing unit 120 by using decoded content that was derived from encoded content received from the source device 102. In turn the display processor 127 may be configured to perform display processing on the one or more frames generated by the processing unit 120. The one or more displays 131 may be configured to display or otherwise present frames processed by the display processor 127. In some examples, the one or more display devices may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content decoder 122, such as system memory 124, may be accessible to the processing unit 120 and the content decoder 122. For example, the processing unit 120 and the content decoder 122 may be configured to read from and/or write to external memory, such as the system memory 124. The processing unit 120 and the content decoder 122 may be communicatively coupled to the system memory 124 over a bus. In some examples, the processing unit 120 and the content decoder 122 may be communicatively coupled to each other over the bus or a different connection.

The content decoder 122 may be configured to receive graphical content from any source, such as the system memory 124 and/or the communication interface 126. The system memory 124 may be configured to store received encoded graphical content, such as encoded graphical content received from the source device 102. The content decoder 122 may be configured to receive encoded graphical content (e.g., from the system memory 124 and/or the communication interface 126) in the form of encoded pixel data. The content decoder 122 may be configured to decode encoded graphical content.

The internal memory 121, the system memory 124, and/or the internal memory 123 may include one or more volatile or non-volatile memories or storage devices. In some examples, internal memory 121, the system memory 124, and/or the internal memory 123 may include random access memory (RAM), static RAM (SRAM), dynamic RAM (DRAM), erasable programmable ROM (EPROM), electrically erasable programmable ROM (EEPROM). Flash memory, a magnetic data media or an optical storage media, or any other type of memory.

The internal memory 121, the system memory 124, and/or the internal memory 123 may be a non-transitory storage medium according to some examples. The term “non-transitory” may indicate that the storage medium is not embodied in a carrier wave or a propagated signal. However, the term “non-transitory” should not be interpreted to mean that internal memory 121, the system memory 124, and/or the internal memory 123 is non-movable or that its contents are static. As one example, the system memory 124 may be removed from the destination device 104 and moved to another device. As another example, the system memory 124 may not be removable from the destination device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the destination device 104. In some examples, the processing unit 120 may be present on a graphics card that is installed in a port in a motherboard of the destination device 104, or may be otherwise incorporated within a peripheral device configured to interoperate with the destination device 104.

The processing unit 120 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium (e.g., internal memory 121), and may execute the instructions in hardware using one or more processors to perform the techniques of this disclosure. Any of the foregoing (including hardware, software, a combination of hardware and software, etc.) may be considered to be one or more processors.

The content decoder 122 may be any processing unit configured to perform content decoding. In some examples, the content decoder 122 may be integrated into a motherboard of the destination device 104. The content decoder 122 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the content decoder 122 may store instructions for the software in a suitable, non-transitory computer-readable storage medium (e.g., internal memory 123), and may execute the instructions in hardware using one or more processors to perform the techniques of this disclosure. Any of the foregoing (including hardware, software, a combination of hardware and software, etc.) may be considered to be one or more processors.

The communication interface 126 may include a receiver 128 and a transmitter 130. The receiver 128 may be configured to perform any receiving function described herein with respect to the destination device 104. For example, the receiver 128 may be configured to receive information from the source device 102, which may include encoded content, such as encoded graphical content produced or otherwise generated by the processing unit 106 and the content encoder 108 of the source device 102 (i.e., the graphical content is produced by the processing unit 106, which the content encoder 108 receives as input to produce or otherwise generate the encoded graphical content). As another example, the receiver 128 may be configured to receive position information from the source device 102, which may be encoded or unencoded (i.e., not encoded). In some examples, the destination device 104 may be configured to decode encoded graphical content received from the source device 102 in accordance with the techniques described herein. For example, the content decoder 122 may be configured to decode encoded graphical content to produce or otherwise generate decoded graphical content. The processing unit 120 may be configured to use the decoded graphical content to produce or otherwise generate one or more frames for presentment on the one or more displays 131. The transmitter 130 may be configured to perform any transmitting function described herein with respect to the destination device 104. For example, the transmitter 130 may be configured to transmit information to the source device 102, which may include a request for content. The receiver 128 and the transmitter 130 may be combined into a transceiver 132. In such examples, the transceiver 132 may be configured to perform any receiving function and/or transmitting function described herein with respect to the destination device 104.

The content encoder 108 and the content decoder 122 of content generation and coding system 100 represent examples of computing components (e.g., processing units) that may be configured to perform one or more techniques for encoding content and decoding content in accordance with various examples described in this disclosure, respectively. In some examples, the content encoder 108 and the content decoder 122 may be configured to operate in accordance with a content coding standard, such as a video coding standard, a display stream compression standard, or an image compression standard.

As shown in FIG. 1, the source device 102 may be configured to generate encoded content. Accordingly, the source device 102 may be referred to as a content encoding device or a content encoding apparatus. The destination device 104 may be configured to decode the encoded content generated by source device 102. Accordingly, the destination device 104 may be referred to as a content decoding device or a content decoding apparatus. In some examples, the source device 102 and the destination device 104 may be separate devices, as shown. In other examples, source device 102 and destination device 104 may be on or part of the same computing device. In either example, a graphics processing pipeline may be distributed between the two devices. For example, a single graphics processing pipeline may include a plurality of graphics processes. The graphics processing pipeline 107-1 may include one or more graphics processes of the plurality of graphics processes. Similarly, graphics processing pipeline 107-2 may include one or more processes graphics processes of the plurality of graphics processes. In this regard, the graphics processing pipeline 107-1 concatenated or otherwise followed by the graphics processing pipeline 107-2 may result in a full graphics processing pipeline. Otherwise described, the graphics processing pipeline 107-1 may be a partial graphics processing pipeline and the graphics processing pipeline 107-2 may be a partial graphics processing pipeline that, when combined, result in a distributed graphics processing pipeline.

In some examples, a graphics process performed in the graphics processing pipeline 107-1 may not be performed or otherwise repeated in the graphics processing pipeline 107-2. For example, the graphics processing pipeline 107-1 may include receiving first position information corresponding to a first orientation of a device. The graphics processing pipeline 107-1 may also include generating first graphical content based on the first position information. Additionally, the graphics processing pipeline 107-1 may include generating motion information for warping the first graphical content. The graphics processing pipeline 107-1 may further include encoding the first graphical content. Also, the graphics processing pipeline 107-1 may include providing the motion information and the encoded first graphical content. The graphics processing pipeline 107-2 may include providing first position information corresponding to a first orientation of a device. The graphics processing pipeline 107-2 may also include receiving encoded first graphical content generated based on the first position information. Further, the graphics processing pipeline 107-2 may include receiving motion information. The graphics processing pipeline 107-2 may also include decoding the encoded first graphical content to generate decoded first graphical content. Also, the graphics processing pipeline 107-2 may include warping the decoded first graphical content based on the motion information. By distributing the graphics processing pipeline between the source device 102 and the destination device 104, the destination device may be able to, in some examples, present graphical content that it otherwise would not be able to render; and, therefore, could not present. Other example benefits are described throughout this disclosure.

As described herein, a device, such as the source device 102 and/or the destination device 104, may refer to any device, apparatus, or system configured to perform one or more techniques described herein. For example, a device may be a server, a base station, user equipment, a client device, a station, an access point, a computer (e.g., a personal computer, a desktop computer, a laptop computer, a tablet computer, a computer workstation, or a mainframe computer), an end product, an apparatus, a phone, a smart phone, a server, a video game platform or console, a handheld device (e.g., a portable video game device or a personal digital assistant (PDA)), a wearable computing device (e.g., a smart watch, an augmented reality device, or a virtual reality device), a non-wearable device, an augmented reality device, a virtual reality device, a display (e.g., display device), a television, a television set-top box, an intermediate network device, a digital media player, a video streaming device, a content streaming device, an in-car computer, any mobile device, any device configured to generate graphical content, or any device configured to perform one or more techniques described herein.

Source device 102 may be configured to communicate with the destination device 104. For example, destination device 104 may be configured to receive encoded content from the source device 102. In some example, the communication coupling between the source device 102 and the destination device 104 is shown as link 134. Link 134 may comprise any type of medium or device capable of moving the encoded content from source device 102 to the destination device 104.

In the example of FIG. 1, link 134 may comprise a communication medium to enable the source device 102 to transmit encoded content to destination device 104 in real-time. The encoded content may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 102 to the destination device 104. In other examples, link 134 may be a point-to-point connection between source device 102 and destination device 104, such as a wired or wireless display link connection (e.g., an HDMI link, a DisplayPort link, MIPI DSI link, or another link over which encoded content may traverse from the source device 102 to the destination device 104.

In another example, the link 134 may include a storage medium configured to store encoded content generated by the source device 102. In this example, the destination device 104 may be configured to access the storage medium. The storage medium may include a variety of locally-accessed data storage media such as Blu-ray discs, DVDs. CD-ROMs, flash memory, or other suitable digital storage media for storing encoded content.

In another example, the link 134 may include a server or another intermediate storage device configured to store encoded content generated by the source device 102. In this example, the destination device 104 may be configured to access encoded content stored at the server or other intermediate storage device. The server may be a type of server capable of storing encoded content and transmitting the encoded content to the destination device 104.

Devices described herein may be configured to communicate with each other, such as the source device 102 and the destination device 104. Communication may include the transmission and/or reception of information. The information may be carried in one or more messages. As an example, a first device in communication with a second device may be described as being communicatively coupled to or otherwise with the second device. For example, a client device and a server may be communicatively coupled. As another example, a server may be communicatively coupled to a plurality of client devices. As another example, any device described herein configured to perform one or more techniques of this disclosure may be communicatively coupled to one or more other devices configured to perform one or more techniques of this disclosure. In some examples, when communicatively coupled, two devices may be actively transmitting or receiving information, or may be configured to transmit or receive information. If not communicatively coupled, any two devices may be configured to communicatively couple with each other, such as in accordance with one or more communication protocols compliant with one or more communication standards. Reference to “any two devices” does not mean that only two devices may be configured to communicatively couple with each other; rather, any two devices is inclusive of more than two devices. For example, a first device may communicatively couple with a second device and the first device may communicatively couple with a third device. In such an example, the first device may be a server.

With reference to FIG. 1, the source device 102 may be described as being communicatively coupled to the destination device 104. In some examples, the term “communicatively coupled” may refer to a communication connection, which may be direct or indirect. The link 134 may, in some examples, represent a communication coupling between the source device 102 and the destination device 104. A communication connection may be wired and/or wireless. A wired connection may refer to a conductive path, a trace, or a physical medium (excluding wireless physical mediums) over which information may travel. A conductive path may refer to any conductor of any length, such as a conductive pad, a conductive via, a conductive plane, a conductive trace, or any conductive medium. A direct communication connection may refer to a connection in which no intermediary component resides between the two communicatively coupled components. An indirect communication connection may refer to a connection in which at least one intermediary component resides between the two communicatively coupled components. Two devices that are communicatively coupled may communicate with each other over one or more different types of networks (e.g., a wireless network and/or a wired network) in accordance with one or more communication protocols. In some examples, two devices that are communicatively coupled may associate with one another through an association process. In other examples, two devices that are communicatively coupled may communicate with each other without engaging in an association process. For example, a device, such as the source device 102, may be configured to unicast, broadcast, multicast, or otherwise transmit information (e.g., encoded content) to one or more other devices (e.g., one or more destination devices, which includes the destination device 104). The destination device 104 in this example may be described as being communicatively coupled with each of the one or more other devices. In some examples, a communication connection may enable the transmission and/or receipt of information. For example, a first device communicatively coupled to a second device may be configured to transmit information to the second device and/or receive information from the second device in accordance with the techniques of this disclosure. Similarly, the second device in this example may be configured to transmit information to the first device and/or receive information from the first device in accordance with the techniques of this disclosure. In some examples, the term “communicatively coupled” may refer to a temporary, intermittent, or permanent communication connection.

Any device described herein, such as the source device 102 and the destination device 104, may be configured to operate in accordance with one or more communication protocols. For example, the source device 102 may be configured to communicate with (e.g., receive information from and/or transmit information to) the destination device 104 using one or more communication protocols. In such an example, the source device 102 may be described as communicating with the destination device 104 over a connection. The connection may be compliant or otherwise be in accordance with a communication protocol. Similarly, the destination device 104 may be configured to communicate with (e.g., receive information from and/or transmit information to) the source device 102 using one or more communication protocols. In such an example, the destination device 104 may be described as communicating with the source device 102 over a connection. The connection may be compliant or otherwise be in accordance with a communication protocol.

As used herein, the term “communication protocol” may refer to any communication protocol, such as a communication protocol compliant with a communication standard or the like. As used herein, the term “communication standard” may include any communication standard, such as a wireless communication standard and/or a wired communication standard. A wireless communication standard may correspond to a wireless network. As an example, a communication standard may include any wireless communication standard corresponding to a wireless personal area network (WPAN) standard, such as Bluetooth (e.g., IEEE 802.15), Bluetooth low energy (BLE) (e.g., IEEE 802.15.4). As another example, a communication standard may include any wireless communication standard corresponding to a wireless local area network (WLAN) standard, such as WI-FT (e.g., any 802.11 standard, such as 802.11a, 802.11b, 802.11c, 802.11n, or 802.11ax). As another example, a communication standard may include any wireless communication standard corresponding to a wireless wide area network (WWAN) standard, such as 3G, 4G, 4G LTE, 5G, or 6G.

With reference to FIG. 1, the content encoder 108 may be configured to encode graphical content. In some examples, the content encoder 108 may be configured to encode graphical content as one or more video frames. When the content encoder 108 encodes content, the content encoder 108 may generate a bitstream. The bitstream may have a bit rate, such as bits/time unit, where time unit is any time unit, such as second or minute. The bitstream may include a sequence of bits that form a coded representation of the graphical content and associated data. To generate the bitstream, the content encoder 108 may be configured to perform encoding operations on pixel data, such as pixel data corresponding to a shaded texture atlas. For example, when the content encoder 108 performs encoding operations on image data (e.g., one or more blocks of a shaded texture atlas) provided as input to the content encoder 108, the content encoder 108 may generate a series of coded images and associated data. The associated data may include a set of coding parameters such as a quantization parameter (QP).

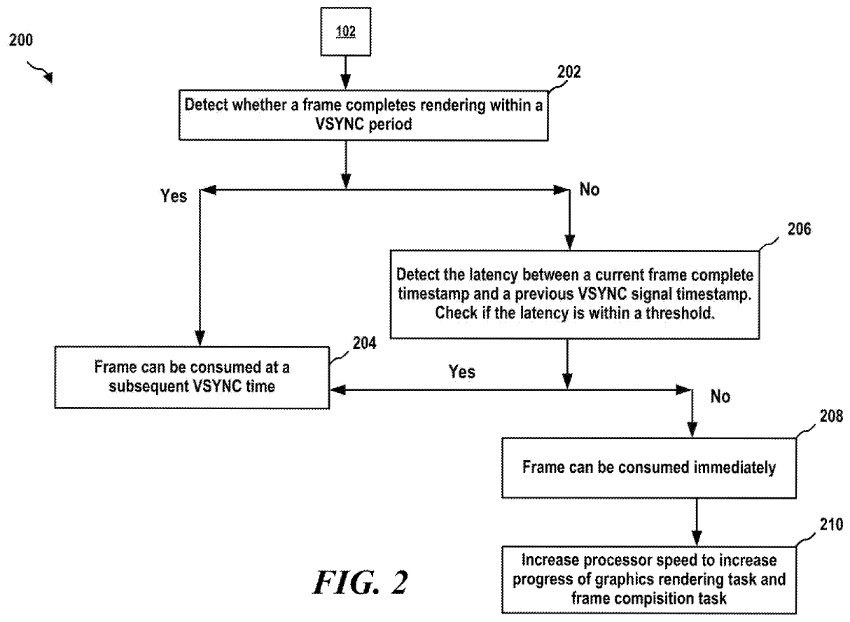

FIG. 2 illustrates an example flow diagram 200 between the source device 102 and the destination device 104, in which penalty-based game load scheduling is performed, in accordance with aspects of the present disclosure. In other examples, one or more techniques described herein may be added to the flow diagram 200 and/or one or more techniques depicted in the flow diagram may be removed.

In the example of FIG. 2, at block 202, the processing unit 106 of the source device 102 may be configured to detect whether a frame completes rendering within a vertical sync (VSYNC) period. If the rendering finishes within a VSYNC period, then at block 204, the frame can still be consumed at a subsequent VSYNC time. If the rendering does not finish within a VSYNC period, then at block 206, the processing unit 106 may be configured to detect the latency between a current fame complete timestamp and a previous VSYNC signal timestamp. If the latency is more than a threshold, then at block 204, the frame may still be consumed at a next VSYNC time. If the latency is within the threshold, then at block 208, the frame can be consumed immediately, as there may be no need to wait for a subsequent VSYNC time. Further, at block 210, the apparatus can increase a processing speed to increase the progress of a graphics rendering task and a frame composition task.

The mobile gaming market is an important market in the mobile world. In this market, users care greatly about the game performance. For example, a frame rate (e.g., a frames per second (FPS) value) is an important key performance indicator (KPI) in the mobile gaming market for improving a user experience. Accordingly, some aspects of the mobile gaming industry are focused on supporting a predetermined frame rate (e.g., 60 FPS). By contrast, conventional techniques for controlling the frame rate are not power optimal and lead to a high number of wasted CPU cycles. For example, conventional gaming applications control a game content frame rate (e.g., FPS) by detecting a frame time (e.g., 16.6 milliseconds (ms) for a frame rate of 60 FPS). The frame time is compared with a game thread runtime value, which varies based on a central processing unit (CPU) operating frequency.

For example, these conventional gaming applications determine available frame headroom when a game thread runtime value is less than the frame time. In response to the frame headroom detection, these conventional gaming applications apply an explicit sleep technique to limit the frame rate to a desired number. Unfortunately, this game content frame rate control technique is not power optimal and leads to a high number of wasted CPU cycles. Another game content frame rate control technique is scheduler yielding (e.g., “sched_yield”), which hands over control for the central processing unit (CPU) to execute another thread. For example, an Unreal engine-based game propagates the “sched__yield” as a hint to the scheduler for task CPU allocation based on a frame time. This game content frame rate control technique, however, leads to an excessive number of yield system calls, which wastes CPU power depending on the number of available CPU tasks. A technique for controlling the frame rate to reduce power consumption and improve battery life of mobile devices is desired.

Some aspects of the present disclosure are directed to penalty-based game thread load scheduling, which provides a solution for controlling the content FPS that reduces power consumption and improves battery life of a mobile device. Some aspects of the present disclosure are directed to a closed-loop method for penalizing game thread loads for reducing CPU power consumption without sacrificing game application performance. Aspects of the present disclosure recognize that an FPS control related system call is a signal/implicit hint from the gaming application, which has a high-performance margin. These aspects of the present disclosure filter and aggregate FPS control related system call hints, which are propagated to the scheduler to penalize game thread load by reducing the CPU frequency. In some aspects of the present disclosure, a closed-loop method is used to control starting and stopping of the game thread load penalization. These aspects of the present disclosure provide a number of advantages and solutions to the mobile gaming industry, such as providing improved frame rate control.

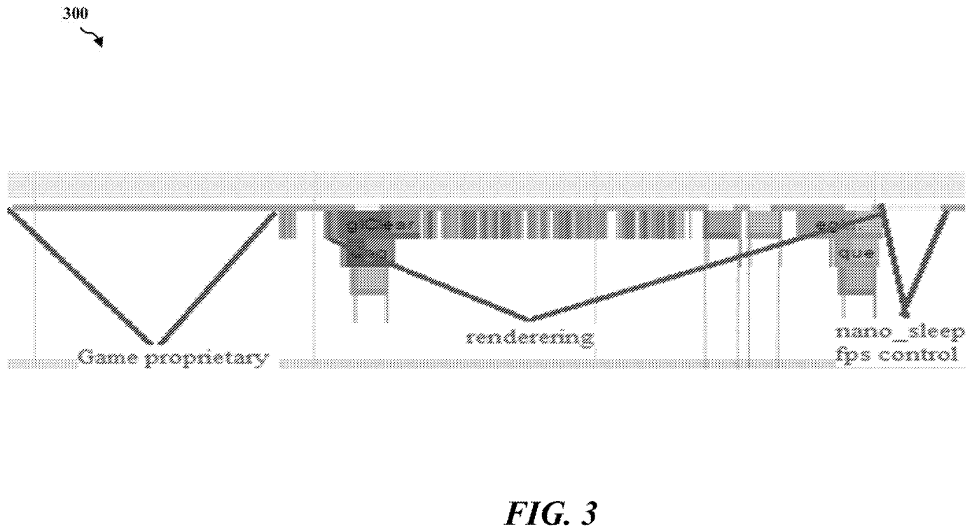

FIG. 3 illustrates an example timing diagram showing game content frame rate control, according to aspects of the present disclosure. In this example, a timing diagram 300 illustrates a frame time (e.g., 16.6 milliseconds) associated with a frame rate of 60 FPS for rendering a game thread. The timing diagram 300 is composed of a game proprietary stage, a rendering stage, and an FPS control stage. In this example, a game thread runtime is composed of a duration of the game proprietary stage and the rendering stage, which varies according to the CPU operating frequency.

In this example, the game thread runtime (e.g., 14 milliseconds) is less than the frame time (e.g., 16.6 milliseconds), resulting in a frame headroom time (e.g., 2.6 milliseconds). In response to the frame detected headroom time, a sleep FPS control method triggers an explicit sleep technique (e.g., nano sleep) during the frame headroom time (e.g., 2.6 milliseconds), which forces a rendering slow down. Alternatively, a yield FPS control method triggers an explicit yield of the game thread for the CPU to run another task during the frame headroom time. A further FPS control method provides a combination of the sleep FPS control method and the yield FPS control method.

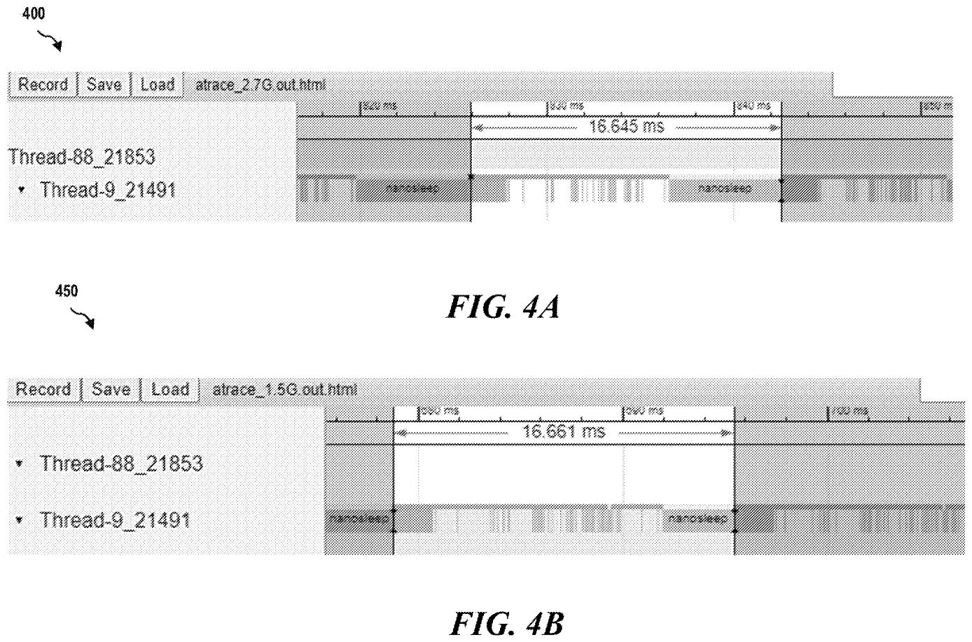

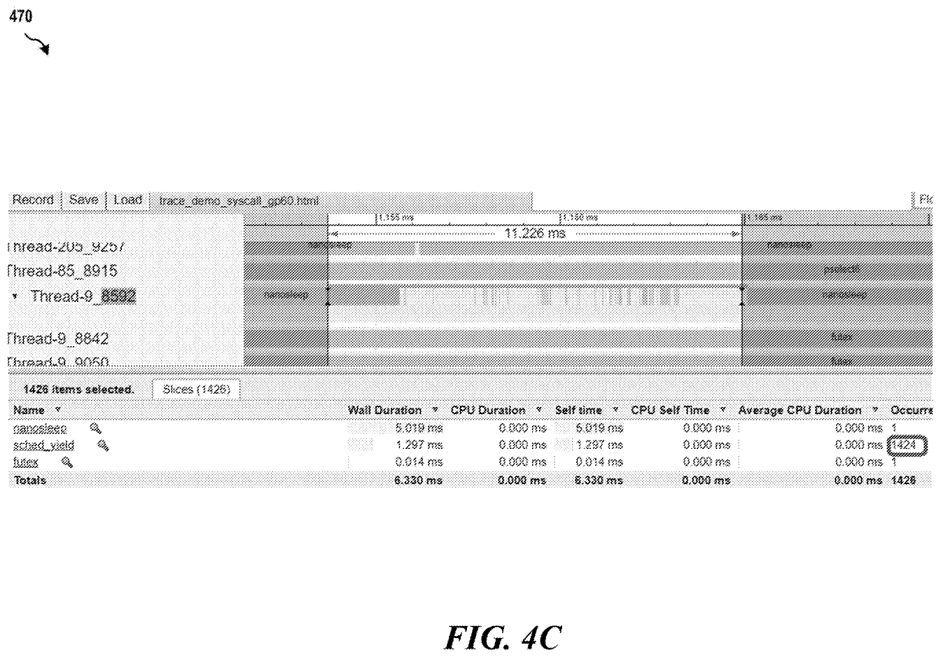

FIGS. 4A and 4B illustrate example timing diagrams showing the sleep frames per second (FPS) control method based on different central processing unit (CPU) operating frequencies, according to aspects of the present disclosure. FIG. 4A illustrates another example a timing diagram 400 based on the sleep FPS control method. In this example, a CPU operating frequency for processing a gaming application is 2.7 gigahertz (Ghz), with a frame rate of 60 FPS and a frame time of 16.6 milliseconds. In this configuration, a game thread runtime is 10.4 milliseconds, which results in a sleep time of 6.2 milliseconds (e.g., 16.6-10.4) and a scheduler yield time of 1.67 milliseconds.

FIG. 4B also illustrates a timing diagram 450 based on the sleep FPS control method. In this example, the CPU operating frequency for processing the gamming application is reduced to 1.5 Ghz, with the same frame rate of 60 FPS and a frame time of 16.6 milliseconds. In this configuration, a game thread runtime increases to 13.1 milliseconds, which results in a sleep time of 3.5 milliseconds (e.g., 16.6-13.1) and a scheduler yield time of 1.65 milliseconds. One problem with the sleep FPS control method is that this method forces rendering to slow down. As shown in FIG. 4A, running the CPU with the high frequency reduces the game thread runtime, which results in a higher sleep time due to the larger frame headroom. Additionally, CPU power (e.g., 600 milliamps) in FIG. 4A is higher relative to the CPU power (e.g., 500 milliamps) in FIG. 4B due to the higher operation frequency (OPP).

FIG. 4C illustrates a timing diagram 470 based on the yield FPS control method. As noted above, the yield FPS control method operates by having the game thread explicitly give up the CPU, which enables other tasks to run. The sched_yield command is part of the portable operating system interface (POSIX) application programming interface (API), which is called by the game thread as a system call to explicitly relinquish the CPU to another task. For example, the UnReal game engine uses the sched_yield command. In this example, the game thread execution includes 5.0 milliseconds of nano sleep with one occurrence, and 1.3 milliseconds of sched_yield, with 1424 occurrences due to the absence of other threads. These 1424 occurrences of sched_yield result in a significantly higher percentage of time taken for the sched_yield command. Unfortunately, this high percentage of sched_yield time, due to the higher CPU frequency, causes an excessive amount of CPU runtime in the sched_yield POSIX APL

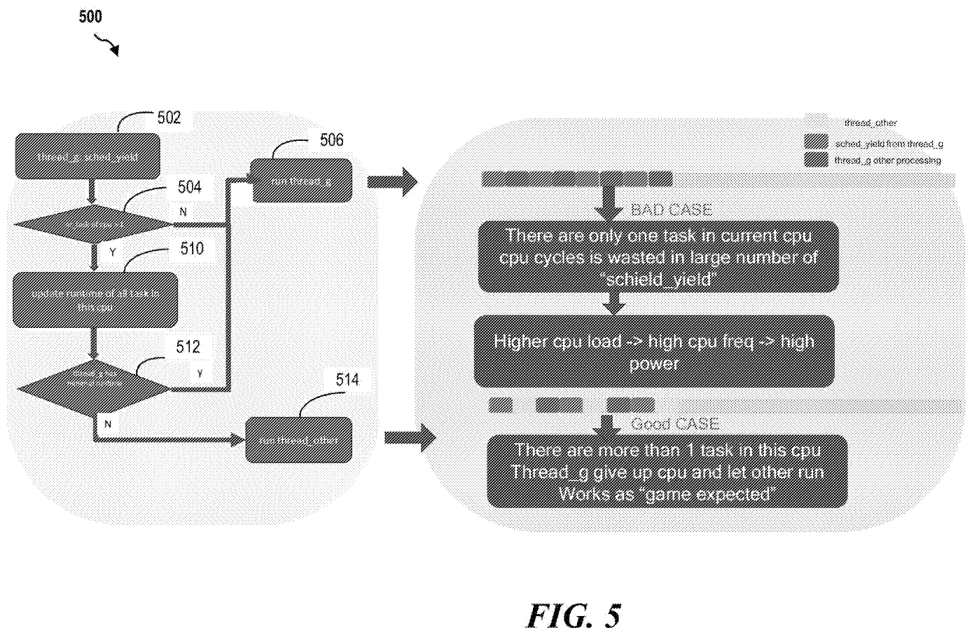

FIG. 5 illustrates an example flow diagram showing thread scheduling during a scheduler yield operation, according to aspects of the present disclosure. As shown in FIG. 5, a yield frames per second (FPS) control method flow diagram 500 begins at a block 502, in which a game thread issues a sched_yield command. At block 504, it is determined whether a number of runnable CPU tasks is greater than one. Unfortunately, when the game thread is the only CPU task, at block 506, the game thread runs again. This detrimental case results because the game thread is the only task currently being executed by the CPU, which significantly wastes CPU cycles due to the significant number of sched_yield calls. The higher CPU load further increases the CPU operating frequency, which results in significant power consumption.

Otherwise, at block 504, control flow branches to block 510, in which the runtime tasks of the CPU are updated. Next, at block 512, it is determined whether the game thread has a minimal runtime. When the game thread has a minimal runtime, the game thread is run again at block 506. Otherwise, control flow branches to block 514, in which another thread is run. Block 514 represents a game expected case, where other tasks are available for execution by the CPU. As a result, the game thread issues a sched_yield command during FPS control.

In operation, CPU frequency is calculated globally, which leads to an imbalance when executing a game thread. For example, sometimes the CPU frequency is over voted, which results in higher game power. At other times, the CPU frequency is under voted, resulting in a reduced CPU frequency and poor game performance. This scenario may be due to a disconnection between the game application FPS control and scheduler operation. Table 1 provides pseudocode for game application FPS control based on a frame time of 16.6 milliseconds (e.g., frame rate of 60 FPS). Based on the pseudocode, a sleep time is based on the difference between the frame time and the game thread runtime, in which nano sleep is performed or a sched_yield command is issued depending on the FPS control method.

TABLE 1
APP Pseudocode to Control FPS

App pseudocode to control fps
frame_time=16.6ms (60fps)
t1 = gettimeofday( )
run_game_logic( )
t2 = gettimeofday( )
sleep(frame_time−(t2−t1))

TABLE 2
Scheduler Pseudocode to Control CPU Frequency

Scheduler pseudocode
window_time=16ms (60fps)
load(cpu) = load(task1 +task2 +...)
freq = load(cpu)/capacity(cpu) * 1.25

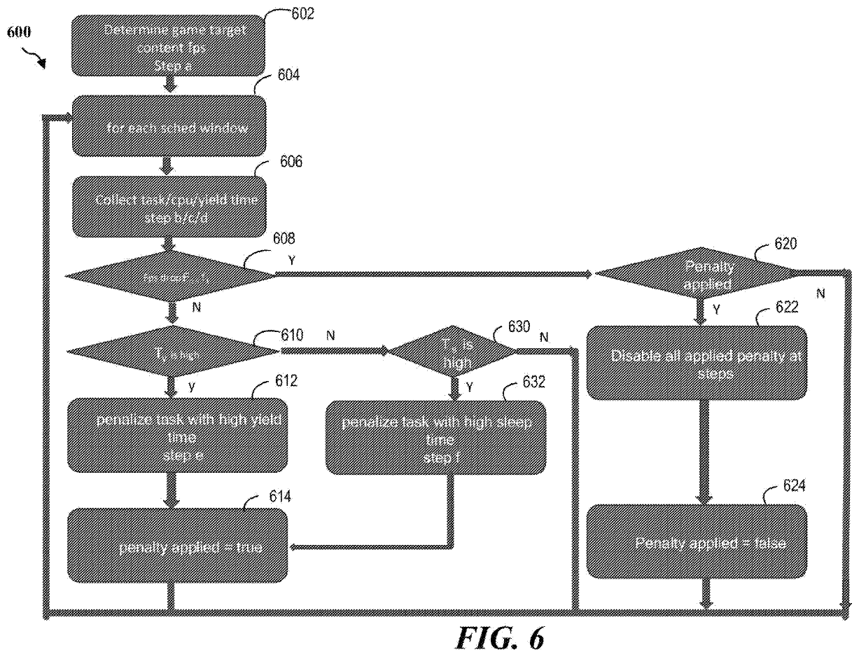

As shown in Table 2, the scheduler pseudocode is based on a scheduler window of 16 milliseconds (e.g., frame rate of 60 FPS). The scheduler pseudocode determines a CPU load (e.g., load(CPU)) based on a load function and the number of task loads (e.g., load(task1+task2+ . . . )). Once the CPU load is determined, the CPU frequency is calculated based on the CPU load (e.g., load (CPU)) divided by a CPU capacity (e.g., capacity(CPU)), with the result multiplied by a scaling factor (e.g., 1.25). Aspects of the present disclosure build a closed loop to penalize task load, which indirectly reduces the CPU frequency and the CPU runtime, for example, as shown in FIG. 6.

FIG. 6 is a flowchart illustrating a method 600 for game thread scheduling during a scheduler yield operation, according to aspects of the present disclosure. As shown in FIG. 6, at block 602, a target frames per second (FPS) is determined. For example, the target FPS may be a frame rate of 60 FPS. At block 604, the blocks 604 to 624 are repeated for each scheduler window. At block 606, a game thread runtime (Tt), a time in sched_yield (Ty) (e.g., a yield syscall time), a gettimeofday syscall time (Tg) or time of day, a sleep time (Ts) in the rendering task, and a last N frame average FPS (e.g., current FPS (Fc) are collected. For example, block 606 may be performed as shown in steps b to d of Table 3. At block 608, it is determined whether a frame drop has occurred. In this example, a frame drop occurs when the current FPS (Fc) is less than the target FPS (ft). When a frame drop is detected, the game thread load penalization is halted and control flow branches to block 620, in which any penalties applied in a previous scheduler window are disabled at block 622 and the penalty applied flag is set to false at block 624.

TABLE 3
CPU Frequency Control Pseudocode

| ▪ | Step a: | |
|---|---|---|
| | ▪ | Inferenced target fps fₜ |
| ▪ | Step b: collect game task running time, | |
| | | time in sched_yield/gettiemofday |
| | ▪ | T_{t,} T_{y}, T_{g} |
| ▪ | Step c: collect sleep time in rendering task | |
| | ▪ | Tₛ |
| ▪ | Step d: collect last N frame average fps | |
| | ▪ | F_{c} |
| ▪ | Step e: | |
| | ▪ | penalize with higher cost in sched_yield |
| | ▪ | Subtract task “total_time in sched_yield” from task load : |
| | ▪ | T_{t =} Tₜ₋ T_{y-} T_{g} |
| | ▪ | Subtract task “total_time in sched_yield” from cpu load |
| ▪ | step f: | |
| | ▪ | penalize game render thread with high sleep time |
| | ▪ | subtract sleep time from task load : T_{t =} Tₜ₋ Tₛ/N |
| | | ▪ N is a tunable like 4 |

Referring again to block 608, when the current FPS (Fc) is not less than the target FPS (ft), frame headroom is detected, which triggers the penalty-based game thread load scheduling, which begins at block 610. At block 610, it is determined whether the time in yield (Ty) is high (e.g., the time in yield Ty is greater than a predetermined value). When the time in yield Ty is high, at block 612, the game thread having the high yield is penalized and the penalty applied flag is set to true at block 614. For example, as shown in step e of Table 3, a sched_yield penalization is performed by subtracting a task total_time in sched_yield (Ty−Tg) from task load Tt (e.g., Tt=Tt−Ty−Tg) to provide a reduced task load. Reducing the task load Tt by the total time in sched_yield also includes subtracting the task total_time in sched_yield from the CPU load, as shown in step e of Table 3. This reduction in the CPU load results in a lower CPU frequency as well as a reduction in the frame headroom.

Otherwise, at block 630 it is determined whether the time in sleep (Ts) is high. When the time in sleep Ts is high (e.g., the time in sleep Ts is greater than a predetermined value), at block 632, the game thread having the high sleep time is penalized and the penalty applied flag is set to true at block 614. For example, as shown in step f of Table 3, a sleep time penalization is performed by penalizing the game render thread with the high sleep time. For example, the penalization is performed by subtracting an average sleep time (Ts/N) from the task load Tt (e.g., Tt=Tt−Ts/N), where N (e.g., 4) is a tunable parameter. Reducing the task load Tt by the average sleep time (Ts/N) is equivalent to subtracting the average sleep time from the CPU load. This reduction in the CPU load also results in a lower CPU frequency.

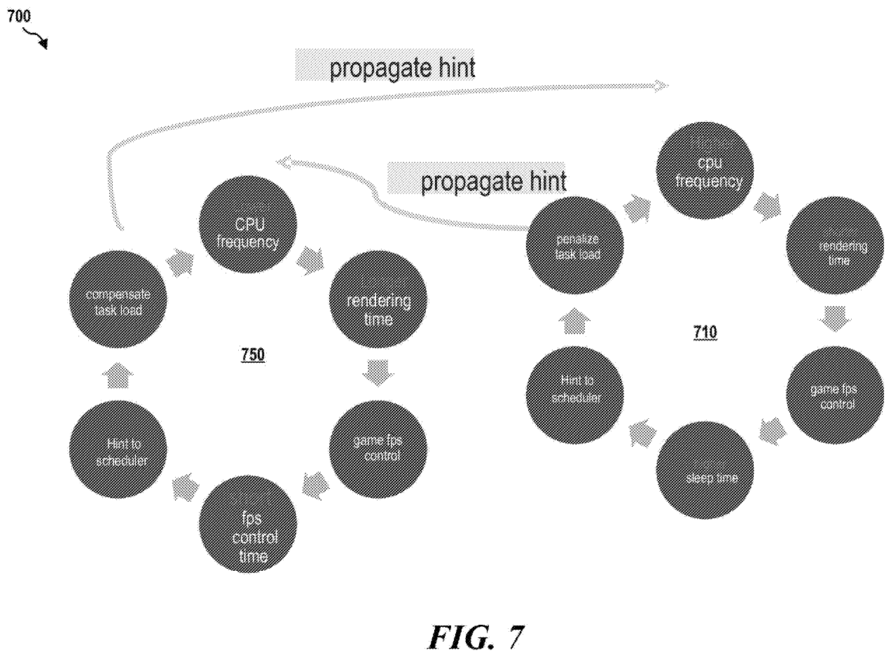

FIG. 7 is a state diagram 700 further illustrating a closed-loop method for the penalty-based game thread load scheduling of FIG. 6, according to aspects of the present disclosure. Some aspects of the present disclosure build a closed loop FPS control including a high CPU frequency loop 710 to penalize game thread loads and a low CPU frequency loop 750, which indirectly reduces CPU frequency and CPU runtime. In the high CPU frequency loop 710, a shorter rendering time due to the high CPU frequency triggers game FPS control based on the higher sleep time. In response, a hint is issued to the scheduler and the game thread load is penalized. Additionally, a transition occurs from the high CPU frequency loop 710 to the low CPU frequency loop 750.

For example, penalizing the game thread load is performed by subtracting a task total_time in sched_yield from task_load in the CPU load calculation shown in Tables 2 and 3. In this example, task1 may be the task load of the game thread, which is initially set to the load of the game thread. Subtracting the total time in sched_yield, from the task load value of the game thread decreases the CPU load calculation, which results in a lower CPU frequency (e.g., a reduced CPU capacity). As a result, the game thread experiences a reduced amount of frame headroom, which leads to a reduced number of issued sched_yield command system calls. The reduced number of issued sched_yield command system calls lead to less CPU sched_yield waste cycles.

In some aspects of the present disclosure, penalizing the game thread load is performed by subtracting a render task sleep time (e.g., “sleep_time/N”) from the task load of the game thread. As described above, subtracting the render task sleep time from the task load value of the game thread decreases the CPU load calculation, which results in a lower CPU frequency. As a result, the game thread experiences a reduced amount of frame headroom due to the reduced CPU frequency, which leads to less sleep time and lower power, as shown in the low CPU frequency loop 750. The method of penalizing the game thread load may be performed by monitoring the FPS health status, and discontinuing the penalizing of the game thread load if a frame drop detected. In this example, frame drop detection results in a transition to the high CPU frequency loop 710, including an increased capacity CPU, from the low CPU frequency loop 750, including a lower capacity CPU. Penalizing and slowing down the game thread causes the game thread to issue fewer FPS related system calls and less sleep time. By monitoring the game FPS control activity from a system side, and then propagating a hint to the scheduler for running at a lower frequency, excessive sched_yield overhead from gaming applications is avoided.

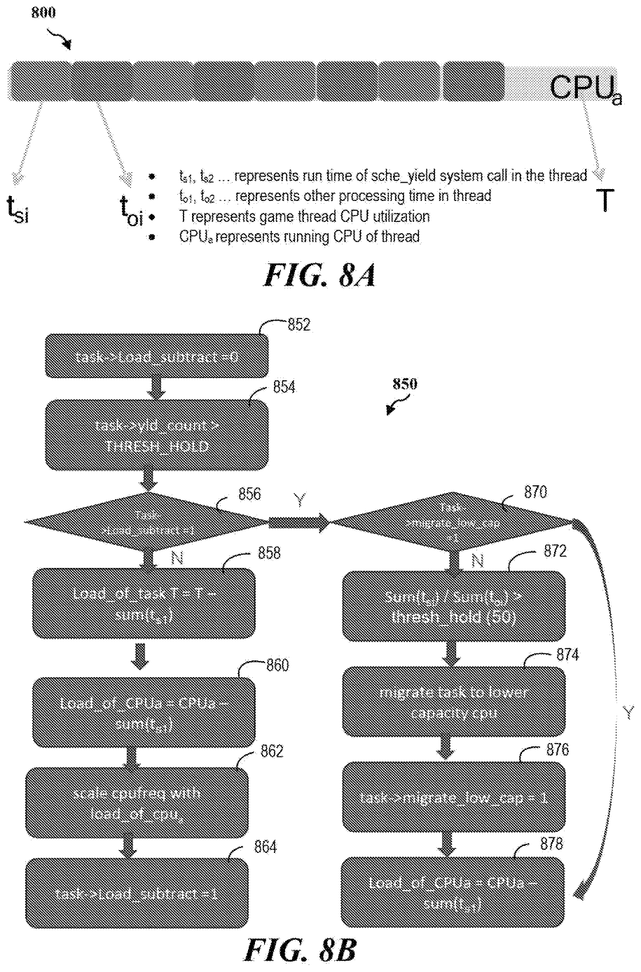

FIGS. 8A-8B illustrate a timing diagram to implement scheduler yield subtraction and a flowchart illustrating a scheduler yield subtraction of the penalty-based game thread load scheduling, according to aspects of the present disclosure. As shown in FIG. 8A, a timing diagram 800 illustrates a CPU, running a game thread that issues sched_yield system calls during detected frame headroom. In this example, tₛ₁, tₛ₂ represent a run time of a sched_yield system call in the CPU thread. Additionally, tₒ₁, tₒ₂ represent other processing time in the CPU thread, and T is game thread CPU utilization, in which the CPUa is running the game thread.

FIG. 8B is a flowchart 850 illustrating an example of a detailed solution for implementing sched_yield subtraction, according to aspects of the present disclosure. At block 852, a load subtract flag is initialized (e.g., task->Load_subtract=0). At block 854, a task yield count is greater than a predetermined threshold value (e.g., task->yld_count>THRESH_HOLD). At block 856, it is determined whether sched_yield subtraction was performed during a previous cycle (e.g., Task->Load_subtract=1). If sched_yield subtraction was not performed during a previous cycle (e.g., Task->Load_subtract=0), control flow branches to block 858 in which a sum of the runtime in sched_yield is subtracted from the task load (e.g., Load_of_task T−T−sum (tₛ₁)). At block 860, the total time in sched_yield is subtracted from task load (e.g., Load_of_CPUa=CPUa−sum (tₛ₁)). At block 862, the CPU frequency is scaled according to the reduced CPU load (e.g., load_of_CPUa), and at block 864 the load subtract flag is set to 1 (e.g., task->Load_subtract=1). As a result, the CPU frequency is lower, which leads to fewer issued sched_yield system calls, resulting in less wasted cycles.

At block 856, if sched_yield subtraction was performed during a previous cycle (e.g., Task->Load_subtract=1), the subtraction did not work, and control flow branches to block 870. This example assumes a mobile application including multiple CPUs, such as a golden CPU, which operates at a highest frequency range, down to a CPU operating at a lower frequency range. At block 870, if the game thread was not previously moved to a low capacity CPU (e.g., Task->migrate_low_cap=1), control flow branches to block 878. Otherwise, control flow branches to block 872 (e.g., Task->migrate_low_cap=0). At block 872, a sum of the time in sched_yield is divided by a sum of other processing time in the thread and compared to a threshold (Sum(tₛᵢ)/Sum(tₒᵢ))>thresh_hold (50). At block 874, the sched_yield task is migrated from a higher capacity CPU to lower capacity CPU. At block 876, the migrate flag is set to 1 (e.g., Task->migrate_low_cap=1), and at block 878, “sched_yield” number is used to further throttle the CPUa load (e.g., Load_of_CPUa=CPUa−sum(tₛᵢ).

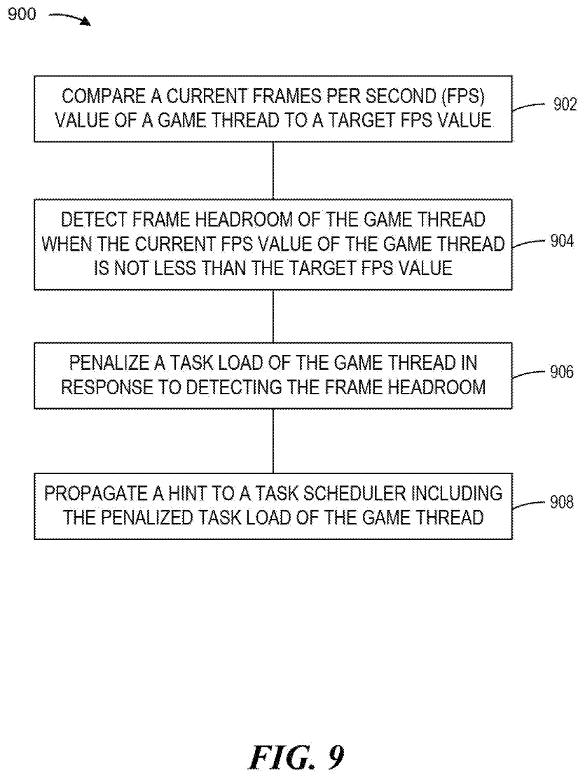

FIG. 9 is a flowchart illustrating a method for penalty-based game thread load scheduling, according to aspects of the present disclosure. A method 900 begins at block 902, in which a current frames per second (FPS) value of a game thread is compared to a target FPS value. For example, as shown in FIG. 6, at block 608, a current FPS (Fe) is less is compared with a target FPS (ft). At block 904, frame headroom of the game thread is detected when the current FPS value of the game thread is not less than the target FPS value. For example, as shown in FIG. 6, when the current FPS (Fc) is not less than the target FPS (ft), frame headroom is detected, which triggers the penalty-based game thread load scheduling, which begins at block 610.

At block 906, a task load of the game thread is penalize in response to detecting the frame headroom. For example, as shown in FIG. 6, at block 610, it is determined whether the time in yield (Ty) is high (e.g., the time in yield Ty is greater than a predetermined value). When the time in yield Ty is high, at block 612, the game thread having the high yield is penalized and the penalty applied flag is set to true at block 614. Otherwise, at block 630 it is determined whether the time in sleep (Ts) is high. When the time in sleep Ts is high (e.g., the time in sleep Ts is greater than a predetermined value), at block 632, the game thread having the high sleep time is penalized and the penalty applied flag is set to true at block 614.

At block 908, a hint is propagated to a task scheduler including the penalized task load of the game thread. For example, as shown in FIG. 7, in the high CPU frequency loop 710, a shorter rendering time due to the high CPU frequency triggers game FPS control based on the higher sleep time. In response, a hint is propagated to the scheduler and the game thread load is penalized. Additionally, a transition occurs from the high CPU frequency loop 710 to the low CPU frequency loop 750. As shown in FIG. 6, a frame drop occurs when the current FPS (Fc) is less than the target FPS (ft). When a frame drop is detected, the game thread load penalization is halted and control flow branches to block 620, in which any penalties applied in a previous scheduler window are disabled at block 622 and the penalty applied flag is set to false at block 624.

As described above, the target FPS is some fixed number (e.g., 60), which may be set which is set in a video game startup. In operation a gamming application controls a rendering speed to match the target FPS specified in the video game startup. A current FPS is the measured FPS in game play for a certain instance. It can be calculated by number_of_frame_rendered/time_in_second. When the rendering scheme is properly controlled by the gamming application, the current FPS approximately matches or exceeds the target FPS, which means that no frame drop has occurred. As long as the current FPS is close to but not less than the target FPS, penalty-based game thread load scheduling is applied. This penalization process is stopped once a frame drop is detected(e.g., the current FPS<the target FPS).

In accordance with this disclosure, the term “or” may be interrupted as “and/or” where context does not dictate otherwise. Additionally, while phrases such as “one or more” or “at least one” or the like may have been used for some features disclosed herein but not others; the features for which such language was not used may be interpreted to have such a meaning implied where context does not dictate otherwise.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules, and circuits described in connection with the present disclosure may be implemented or performed with a processor configured according to the present disclosure, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. The processor may be a microprocessor, but, in the alternative, the processor may be any commercially available processor, controller, microcontroller, or state machine specially configured as described herein. A processor may also be implemented as a combination of computing devices. e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functions described throughout the present disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc, where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for penalty-based game thread task load scheduling, the method comprising:
comparing a current frames per second (FPS) value of a game thread to a target FPS value;
detecting frame headroom of the game thread when the current FPS value of the game thread is not less than the target FPS value,
penalizing a task load of the game thread in response to detecting the frame headroom; and
propagating a hint to a task scheduler including the penalized task load of the game thread.

2. The method of claim 1, in which penalizing the task load of the game thread comprises:
determining a game thread runtime, a scheduler yield time, and a time of day; and
when the scheduler yield time is greater than a predetermined value, reducing the task load of the game thread by subtracting the scheduler yield time and the time of day from the game thread runtime.

3. The method of claim 2, in which the scheduler yield time comprises a yield syscall time; and the time of day comprises a getTimeofDay syscall time.

4. The method of claim 1, in which penalizing the task load of the game thread comprises:
determining a sleep time of the game thread; and
reducing the task load of the game thread by subtracting the sleep time from a game thread runtime, when the sleep time is greater than a predetermined value.

5. The method of claim 1, in which propagating the hint to the task scheduler comprises providing a reduced task load for the game thread.

6. The method of claim 1, further comprising reducing a central processing unit (CPU) operating frequency for the game thread according to the penalized task load of the game thread.

7. The method of claim 6, further comprising:
detecting the current FPS value of the game thread is less than the target FPS value; and
increasing the CPU operating frequency in response to the detecting the current FPS value of the game thread is less than the target FPS value.

8. The method of claim 1, further comprising repeating comparing, detecting, penalizing, and propagating until the current FPS value of the game thread is less than the target FPS value.

9. The method of claim 1, further comprising migrating the game thread to a CPU having an increased capacity.

10. The method of claim 1, further comprising:
detecting the frame headroom is greater than a predetermined threshold value after propagating the hint to the task scheduler including the penalized task load of the game thread; and
migrating the game thread to a CPU having a reduced CPU capacity.

11. A non-transitory computer-readable medium having program code recorded thereon for penalty-based game thread task load scheduling, the program code being executed by a processor and comprising:
program code to compare a current frames per second (FPS) value of a game thread to a target FPS value;
program code to detect frame headroom of the game thread when the current FPS value of the game thread is not less than the target FPS value,
program code to penalize a task load of the game thread in response to detecting the frame headroom; and
program code to propagate a hint to a task scheduler including the penalized task load of the game thread.

12. The non-transitory computer-readable medium of claim 11, in which the program code to penalize the task load of the game thread comprises:
program code to determine a game thread runtime, a scheduler yield time, and a time of day; and
when the scheduler yield time is greater than a predetermined value, program code to reduce the task load of the game thread by subtracting the scheduler yield time and the time of day from the game thread runtime.

13. The non-transitory computer-readable medium of claim 12, in which the scheduler yield time comprises a yield syscall time; and the time of day comprises a getTimeofDay syscall time.

14. The non-transitory computer-readable medium of claim 11, in which the program code to penalize the task load of the game thread comprises:
program code to determine a sleep time of the game thread; and
program code to reduce the task load of the game thread by subtracting the sleep time from a game thread runtime, when the sleep time is greater than a predetermined value.

15. The non-transitory computer-readable medium of claim 11, in which the program code to propagate the hint to the task scheduler comprises program code to provide a reduced task load for the game thread.

16. The non-transitory computer-readable medium of claim 11, further comprising program code to reduce a central processing unit (CPU) operating frequency for the game thread according to the penalized task load of the game thread.

17. The non-transitory computer-readable medium of claim 16, further comprising:
program code to detect the current FPS value of the game thread is less than the target FPS value; and
program code to increase the CPU operating frequency in response to the detecting the current FPS value of the game thread is less than the target FPS value.

18. The non-transitory computer-readable medium of claim 11, further comprising program code to repeat the program code to compare, the program code to detect, the program code to penalize, and the program code to propagate until the current FPS value of the game thread is less than the target FPS value.

19. The non-transitory computer-readable medium of claim 11, further comprising program code to migrate the game thread to a CPU having an increased capacity.

20. The non-transitory computer-readable medium of claim 11, further comprising:
program code to detect the frame headroom is greater than a predetermined threshold value after propagating the hint to the task scheduler including the penalized task load of the game thread; and
program code to migrate the game thread to a CPU having a reduced CPU capacity.
